(19) United States
(12) Patent Application Publication
(10) Pub. No.: US 2005/0056326 A1
(43) Pub. Date: Mar. 17, 2005

(54) Fluid passage selecting device

(76) Inventor: Hiroyasu Oide, Obu-City (JP)

Correspondence Address: HARNESS, DICKEY & PIERCE, P.L.C., P.O. BOX 828, BLOOMFIELD HILLS, MI, 48303, US

(21) Appl. No.: 10/938,365

(22) Filed: Sep. 10, 2004

(30) Foreign Application Priority Data
Sep. 17, 2003 (JP) 2003-325133

(51) Int. Cl. F16K 11/065

(52) U.S. Cl. 137/625.48

(57) ABSTRACT

A fluid passage selecting device includes a first passage disposed at an upstream side of a second passage and a third passage that have different width. A slide door is provided to selectively introduce a fluid from the first passage into at least one of the second and third passages. One end of the slide door is slidable between a top end and a bottom end of a downstream edge potion of the first passage. The other end of the slide door is slidable along an extending direction of one of the second and third passages. Accordingly, the two different-width passages can be selectively switched without using an additional door while a fluid flow resistance is decreased.

### CROSS REFERENCE TO RELATED APPLICATION

This application is based on Japanese Patent Application No. 2003-325133 filed on Sep. 17, 2003, the disclosure of which is incorporated herein by reference.

### FIELD OF THE INVENTION

The present invention relates to a fluid passage selecting device for selecting a fluid flow passage.

### BACKGROUND OF THE INVENTION

In an air conditioning device for a vehicle, air from a blower fan is selectively introduced into a passage to flow to an evaporator or a passage to flow to a heater core by using a fluid passage selecting device. The fluid passage selecting device switches between the passages only by sliding a single plate door (for example, referring to JP-A-08-276724, JP-A-08-268040).

Generally, the single plate door is used when the passages leading to the evaporator and the heater core have the same width. In this case, the plate door has a width approximately equal to the passage width, and slides around a branch point between the two passages to selectively introduce air from the blower fan into at least one of the two passages.

When the widths of the two passages are different, the single plate door is required to correspond to the width of the wider passage. However, in this case, it is difficult to open and close the narrower passage.

In an example shown in FIG. 9, a fluid in a first passage 1 is selectively introduced into at least one of a second passage 2 and a third passage 3 which have different widths. Furthermore, the width of a plate door 7a is approximately equal to the width of the narrower second passage 2. When the wider third passage 3 is closed, an additional butterfly door 7b is used to cover a short width part of the plate door 7a. However, when air is introduced into the wider third passage 3, air flow resistance in the wider third passage 3 is increased by a shaft portion 7b1 of the butterfly door 7b.

### SUMMARY OF THE INVENTION

In view of the above-described problems, it is an object of the present invention to provide a fluid passage selecting device for selecting at least one of passages having different widths by using a single door while a resistance to a fluid flow is decreased.

According to the present invention, a fluid passage selecting device includes a first member for defining a first passage through which a fluid flows, a second member for defining a second passage at a downstream side of the first passage in a fluid flow direction, a third member for defining a third passage at a downstream side of the first passage in the fluid flow direction. The third passage has a width different from that of the second passage, and a slide door for opening and closing the second and the third passages is provided so that air from the first passage is introduced to at least one of the second and the third passages. In the fluid passage selecting device, the slide door has a first end that is slidable between one end side and other end side of a downstream edge portion of the first passage, and a second end that is slidable along an extending direction of one of the second passage and the third passage. Accordingly, the fluid from the first passage can be selectively introduced into at least one of the different-width second and third passages without using an additional door such as a butterfly door, and a fluid flow resistance can be decreased.

Preferably, the slide door has a bend portion for changing a flow direction of the fluid flowing from the first passage to one of the second and the third passages. In this case, air flow resistance can be reduced. More preferably, the bend portion of the slide door contacts or substantially contacts a branch portion where the second and the third passages are branched from each other when the second end of the slide door slides along the second passage to close the second passage.

For example, the fluid is air blown from a blower fan, the first passage is an air blowing passage portion of a scroll casing in which the blower fan is disposed, and the bend portion of the slide door is bent approximately in a scrolling direction of the scroll casing. In this case, the second passage is connected to the first passage at an inner side of the third passage in the scrolling direction to have a pressure loss larger than that of the third passage. More preferably, the second passage has a foot opening at a downstream side through which air flows to a lower side of a compartment, and the third passage has a face opening at a downstream side through which air flows to an upper side of the compartment. In this case, air can be smoothly introduced to the face opening and the foot opening while an air amount passing through the face opening can be increased.

### BRIEF DESCRIPTION OF THE DRAWINGS

Other objects, features and advantages of the present invention will become more apparent from the following detailed description made with reference to the accompanying drawings, in which:

FIG. 1 is a schematic sectional view showing a fluid passage selecting device according to a first embodiment of the present invention;

FIG. 2 is a schematic diagram in which the fluid passage selecting device in FIG. 1 is typically used in an air conditioning device for a vehicle, according to the first embodiment;

FIG. 3 is a schematic sectional view showing a fluid passage selecting device having a link unit for sliding a slide door approximately up and down, according to a second embodiment of the present invention;

FIG. 4 is a schematic sectional view showing the fluid passage selecting device in a state where air from a first passage is introduced into a third passage while a second passage is closed by the slide door according to the second embodiment;

FIG. 5 is a schematic sectional view showing the fluid passage selecting device in a state where air from the first passage is introduced into the second passage while the third passage is closed by the slide door according to the second embodiment;

FIG. 6 is a schematic sectional view showing a fluid passage selecting device having a slide unit (slide mechanism) for sliding a slide door approximately up and down, according to a third embodiment of the present invention;

FIG. 7 is a schematic sectional view showing the fluid passage selecting device in a state where air from a first passage is introduced into a third passage while a second passage is closed by the slide door according to the third embodiment;

FIG. 8 is a schematic sectional view showing the fluid passage selecting device in a state where air from the first passage is introduced into the second passage while the third passage is closed by the slide door according to the third embodiment; and

FIG. 9 is a schematic sectional view showing a fluid passage selecting device with a plate door and a butterfly door in a related art.

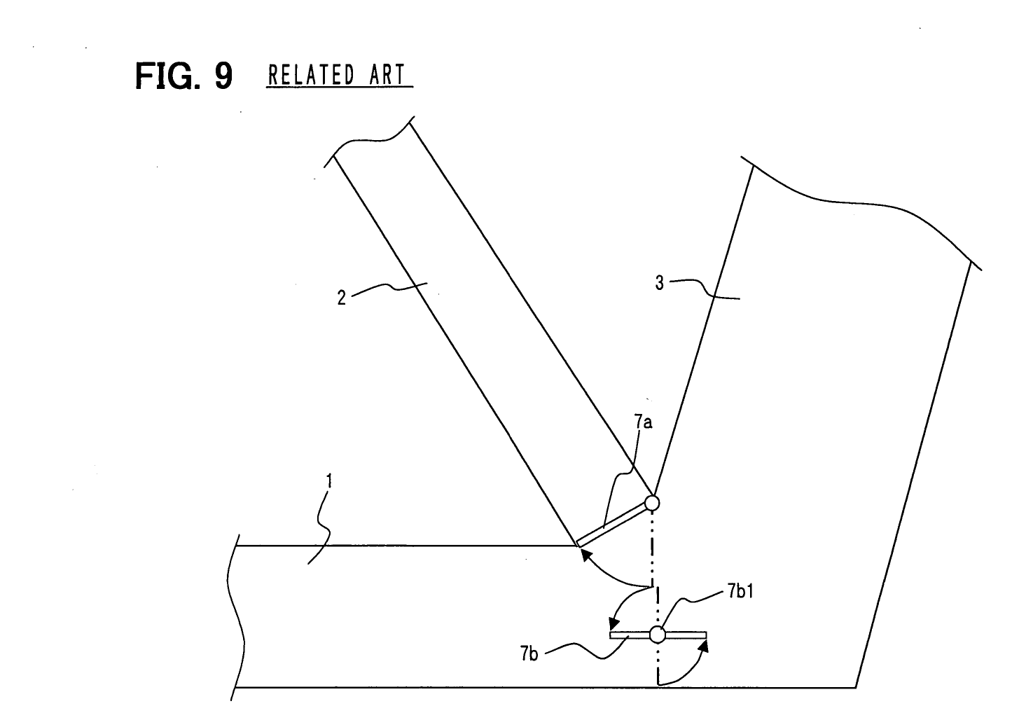

### DETAILED DESCRIPTION OF THE PREFERRED EMBODIMENTS

### First Embodiment

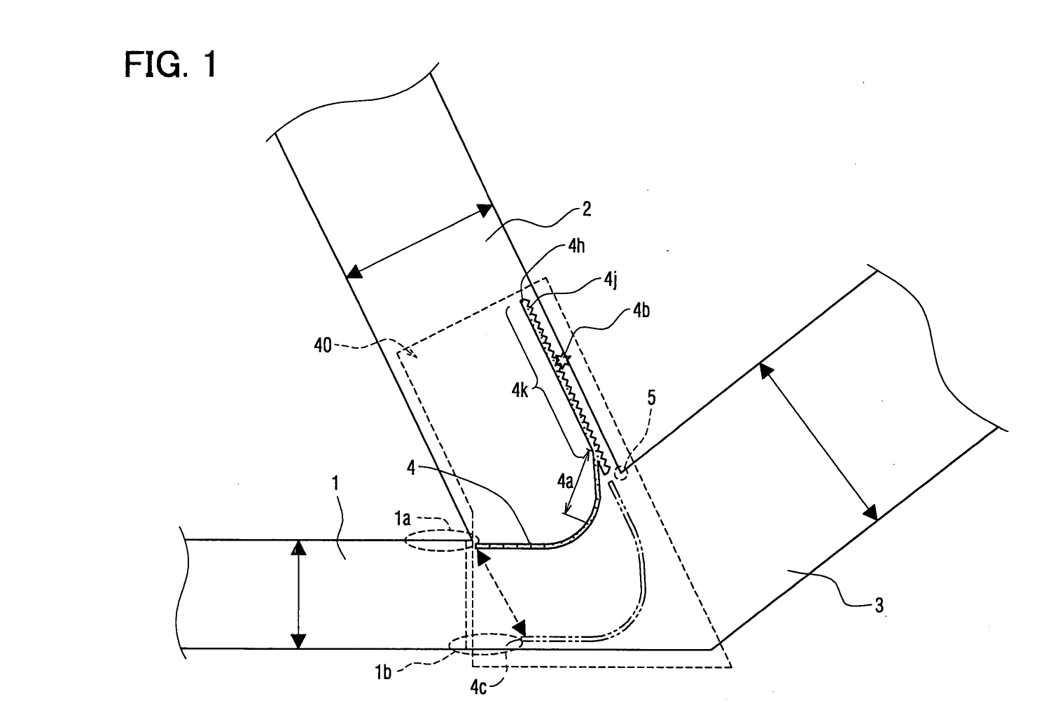

At first, a structure of a fluid passage selecting device 40 according to the present invention is described referring to FIG. 1.

The fluid passage selecting device 40 is used to selectively introduce a fluid from a first passage 1 into at least one of a second passage 2 and a third passage 3. The fluid passage selecting device 40 includes a slide door 4 that has a line portion 4k and a bend portion 4a, racks 4j that are provided on the line portion 4k at a side facing a side wall of the second passage 2 adjacent to the third passage 3, and a first pinion 4b that meshes with the racks 4j.

When the pinion 4b clockwise rotates, one end 4c of the slide door 4 contacts a top end 1a of an downstream edge of the first passage 1, and the other end 4h of the slider door 4 slides along the side wall surface of the second passage 2 and is placed in the second passage 2. Accordingly, the fluid from the first passage 1 is only introduced into the third passage 3.

In this case, the bend portion 4a of the slide door 4 substantially contacts a branch point 5 between the second passage 2 and the third passages 3. That is, the bend portion 4a approximately covers the branch point 5 within the second passage 2, so that the branch point 5 does not obstruct the fluid flowing from the first passage 1 into the third passage 3.

The bend portion 4a can completely contact the branch point 5. However, in the first embodiment, the bend portion 4a is infinitely close to the branch point 5 but it is unnecessary to completely contact the branch point 5 in accordance with a bend shape of the bend portion 4a. Accordingly, an expression “substantially contact” is used.

When the pinion 4b counterclockwise rotates, the other end 4h of the slider door 4 slides along the side wall surface of the second passage 2 and the bend portion 4a protrudes from the second passage 2. The one end 4c of the slide door 4 contacts a bottom end 1b of the downstream edge of the first passage 1. Accordingly, the fluid from the first passage 1 is introduced into the second passage 2 along the bend portion 4a.

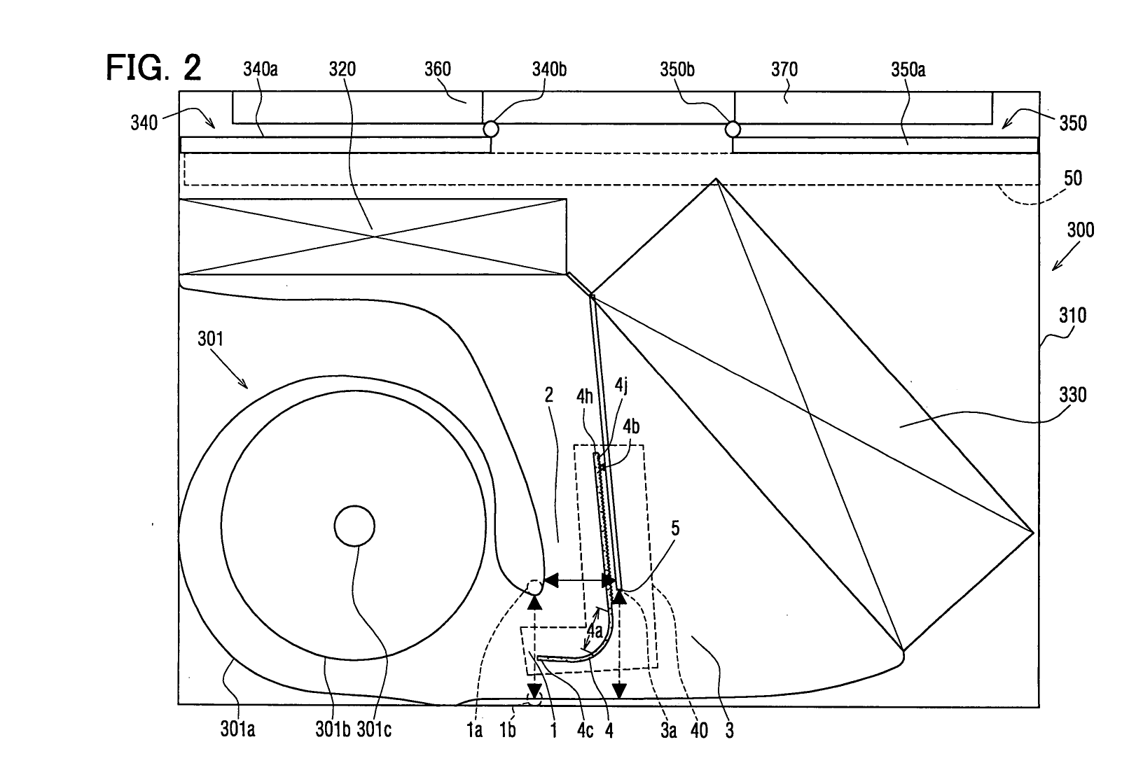

In FIG. 2, the fluid passage selecting device 40 is typically used for a vehicle air conditioning device 300.

As shown in FIG. 2, the air conditioning device 300 is provided with a unit case 310 in which a blower fan 301, the fluid passage selecting device 40, a heater core 320, an evaporator 330, a FOOT door 340 and a FACE door 350 are disposed.

The blower fan 301, as well known, is provided with a scroll casing 301a in which a centrifugal fan 301b and a motor 301c for driving the centrifugal fan 301b are disposed.

In the example of FIG. 2, the first passage 1 is an air blowing passage portion of the scroll casing 301a. The bend portion 4a of the slide door 4 is bent approximately in a scrolling direction of the scroll casing 301a. Air from the first passage 1 flows to the heater core 320 through the second passage 2 and flows to the evaporator 330 through the third passage 3.

The fluid passage selecting device 40 is disposed at a downstream side of the first passage 1 for selectively opening at least one of the second passage 2 and the third passage 3.

The heater core 320 is a heating heat exchanger including multiple layers of stacked flat tubes that are integrally bonded by brazing, and corrugated fins that are placed between adjacent tubes. The flat tube is formed by two pieces of metal plates (i.e., aluminum) by welding, for example. The flat tube has a flat cross section. The heater core 320 heats air using engine-cooling water having a high temperature as a heat source.

The evaporator 330 includes multiple layers of stacked flat tubes that are integrally bonded by brazing, and corrugated fins that are placed between adjacent tubes. The flat tube is formed by two pieces of metal plates (i.e., aluminum). A well-known refrigerant cycle system is constructed with a compressor, a condenser, an expanding valve (not shown), in addition with the evaporator 330. The evaporator 330 is a cooling heat exchanger, in which refrigerant of the refrigerant cycle system evaporates by absorbing heat from air as an evaporation latent heat. Therefore, air passing through the evaporator 330 is cooled and dried.

As described above, by rotating the pinion 4b in the fluid passage selecting device 40, air from the first passage 1 (i.e., air blowing passage portion of the scroll casing 301a) is selectively introduced to at least one of the heater core 320 and the evaporator 330.

A mixing portion 50 is provided at a downstream side of the heater core 320 and the evaporator 330 to mix two kinds of air (i.e., cool air and hot air) that flows from the two heat exchangers 320 and 330. In the mixing portion 50, cool air and hot air are well mixed, so that conditioned air having a comfortable temperature is supplied to a passenger compartment.

A FOOT duct and a FACE duct are provided to be connected to the FOOT air outlet 360 and the FACE air outlet 370, respectively. The FOOT duct for supplying conditioned air to a foot area of a passenger in the passenger compartment is disposed at an inner side in the scrolling direction of the scroll casing 301a, and the FACE duct for supplying conditioned air to a face area of the passenger is disposed at an outer side of the FOOT duct in the scrolling direction. That is, the FOOT air outlet 360 is arranged in the unit case 310 at an inner side of the FACE air outlet 370 in the scrolling direction of the scroll casing 301a. Generally, the passage at the inner side in the scrolling direction has a larger pressure loss than that of the passage at the outer side in the scrolling direction. Therefore, conditioned air is readily blown to the upper area of the passenger more than the foot area of the passenger compartment. The FACE air outlet 370 and the FOOT air outlet 360 are provided at a downstream side (i.e., upper side in FIG. 2) of the mixing portion 50. Further, a FACE door 350 is provided to open and close the FACE air outlet 370. A FOOT door 340 is provided to open and close the FOOT air outlet 360.

The FOOT door 340 includes a FOOT slide plate 340a and a FOOT pinion 340b. Similarly, the FACE door 350 includes a FACE slide plate 350a and a FACE pinion 350b. The FACE pinion 350b and the FOOT pinion 340b rotate and mesh with racks provided on the FACE slide plate 350a and the FOOT slide plate 340a, respectively, so that the FACE slide plate 350a and the FOOT slide plate 340a slide sideways.

Conditioned air having the comfortable temperature is blown into the passenger compartment from at least one of the FOOT air outlet 360 and the FACE air outlet 370, which are opened by the FOOT door 340 and the FACE door 350, respectively.

The operation of the fluid passage selecting device 40 according to the first embodiment will be now described.

The fluid passage selecting device 40 connects with a temperature adjusting unit (not shown) which is provided for the air conditioning device 300. When the passenger operates the temperature adjusting unit, the pinion 4b is rotated clockwise or counterclockwise in accordance with the operation of the temperature adjusting unit. Accordingly, the one end 4c of the slide door 4 slides between the top end 1a and the bottom end 1b of the downstream edge of the first passage 1, and the other end 4h of the slide door 4 slides along the side wall surface of the second passage 2.

In the air conditioning device 300, a maximum cooling mode and a maximum heating mode can be set by the temperature adjusting unit. In the maximum cooling mode, all of air from the first passage 1 can be introduced into the third passage 3 to flow to the evaporator 330. In the maximum heating mode, all of air from the first passage 1 can be introduced into the second passage 2 to flow to the heater core 320. Furthermore, by suitably adjusting an operation position of the temperature adjusting unit, air from the first passage 1 can flow into both of the second passage 2 and the third passage 3, and a temperature adjusting mode can be set.

Advantages of this embodiment will be described as following.

In the fluid passage selecting device 40 of the present invention, the one end 4c of the slide door 4 slides between the top end la and the bottom end 1b of the downstream edge of the first passage 1. The other end 4h of the slide door 4 slides along the side wall surface of the second passage 2. Therefore, the two different-width passages can be selectively opened and closed by using the single slide door 4. Because an additional door is unnecessary, an air flow resistance can be effectively reduced.

Air is blown from the scroll casing 301a approximately in the scrolling direction of the scroll casing 301a. When the one end 4c of the slide door 4 contacts the bottom end 1b of the downstream edge of the first passage 1, air from the first passage 1 is smoothly introduced into the second passage 2, because the bend portion 4a of the slide door 4 is bent approximately in the scrolling direction of the scroll casing 301a. Therefore, a resistance to air flowing from the first passage 1 into the second passage 2 is decreased.

Moreover, when the one end 4c of the first slide door 4 contacts the top end 1a of the downstream edge of the first passage 1, the second passage 2 is closed, and the bend portion 4a substantially contacts the branch point 5. Therefore, the branch point 5 dose not protrude to the third passage 3, and a resistance to air flowing from the first passage 1 to the third passage 3 is decreased.

### Second Embodiment

In the above-described first embodiment, the racks 4j which are provided on the line portion 4k of the slide door 4 and the pinion 4b are provided to slide the slide door 4 approximately in an up-down direction (i.e., vertical direction).

However, as described below, by using a link unit 4g (link mechanism), the slide door 4 can slide just like as in the first embodiment.

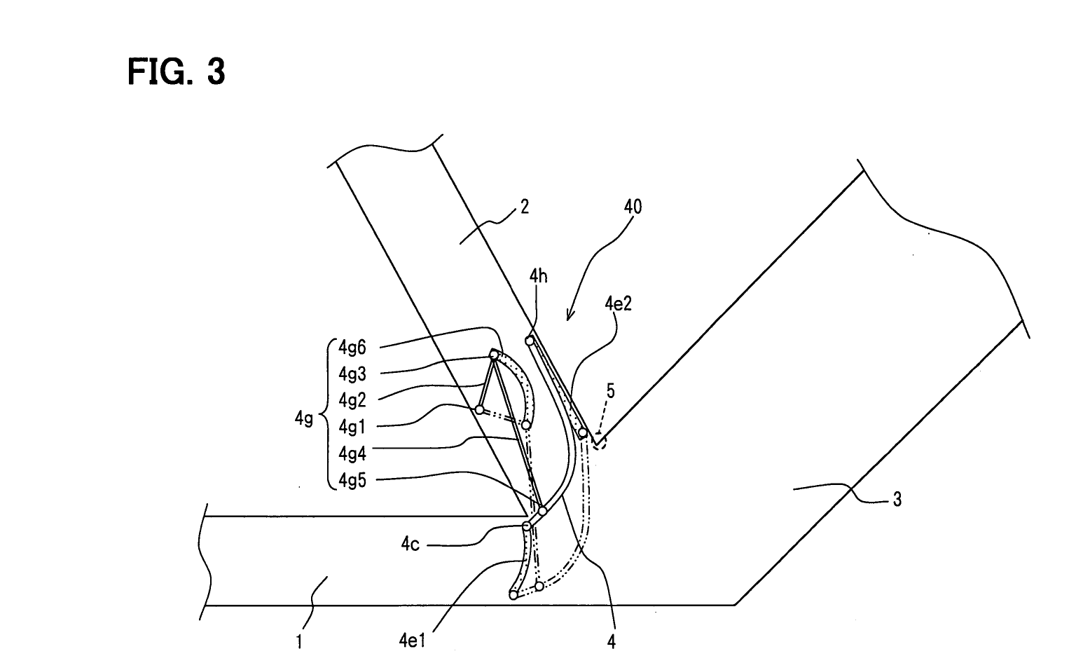

As shown in FIG. 3, the link unit 4g includes a first link pin 4g1, a first link pillar 4g2, a second link pin 4g3, a second link pillar 4g4 and a third link pin 4g5.

The first link pin 4g1 is disposed in an inner wall of the second passage 2 at a side adjacent to the first passage 1. The first link pin 4g1 is joined with a motor shaft of a servomotor (not shown).

The first link pillar 4g2 is a driving pillar. One end of the first link pillar 4g2 is joined with the first link pin 4g1 rotatablely and other end is joined with the second link pin 4g3 rotatablely.

The second link pin 4g3 is a crankshaft, and is joined with the first link pillar 4g2 and the second link pillar 4g4. The second link pin 4g3 is inserted in and slides along a first guiding groove 4g6.

The second link pillar 4g4 is a passive pillar. One end of the second link pillar 4g4 is joined with the second link pin 4g3 rotatablely and other end thereof is joined with the third link pin 4g5 rotatablely.

The third link pin 4g5 is a crankshaft and disposed at a set position of the slide door 4 on a surface at a side facing the second passenger 2. The third link pin 4g5 is joined with the other end of the second link pillar 4g4 rotatablely.

The first guiding groove 4g6 is an arc-shape concave portion provided in the inner wall of the second passage 2 to form an arc orbit. The second link pin 4g3 is inserted in and slides along the arc orbit.

Furthermore, each of the ends 4c and 4h of the slide door 4 is provided with a pin. A second guiding groove 4e1 is provided in the inner wall of the first passage 1, and is an arc-shape concave portion for forming an arc orbit to communicate with the ends 1a and 1b (see FIG. 1) of the first passage 1. The pin at the one end 4c of the slide door 4 is inserted in and slides along the concave portion of the second guiding groove 4e1. A third guiding groove 4e2 is disposed in the inner wall of the second passage 2 at a side separated from the first passage 1. The third guiding groove 4e2 is a concave portion extending lineally from the branch point 5 in an extending direction of the second passage 2. The pin disposed at the other end 4h of the slide door 4 is inserted in and slides along the concave portion of the third guiding groove 4e2.

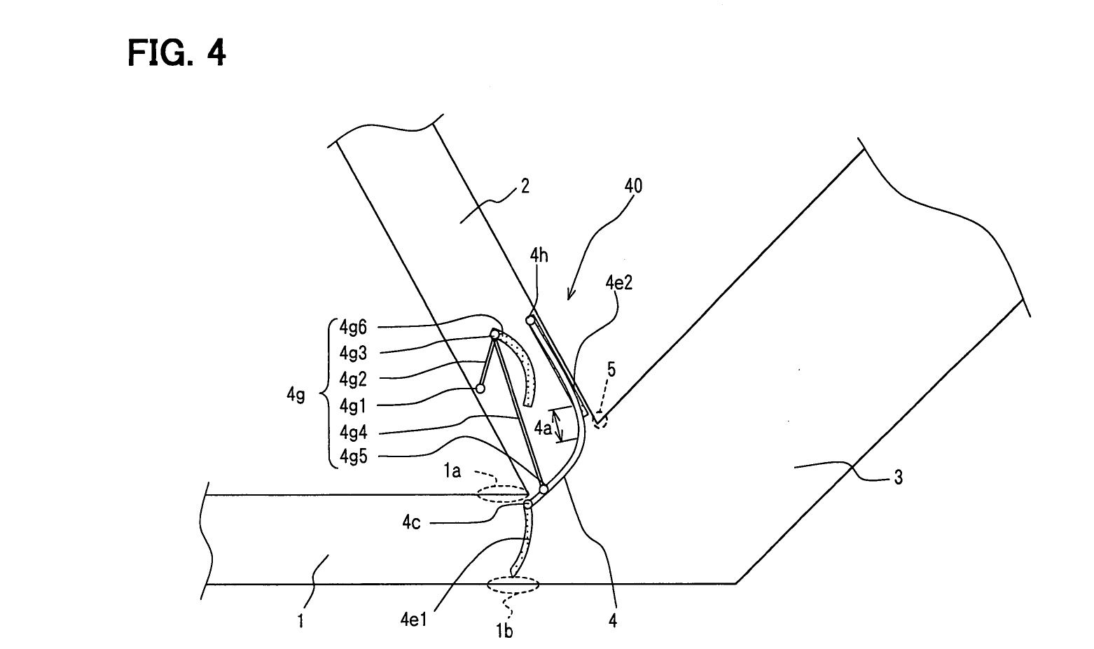

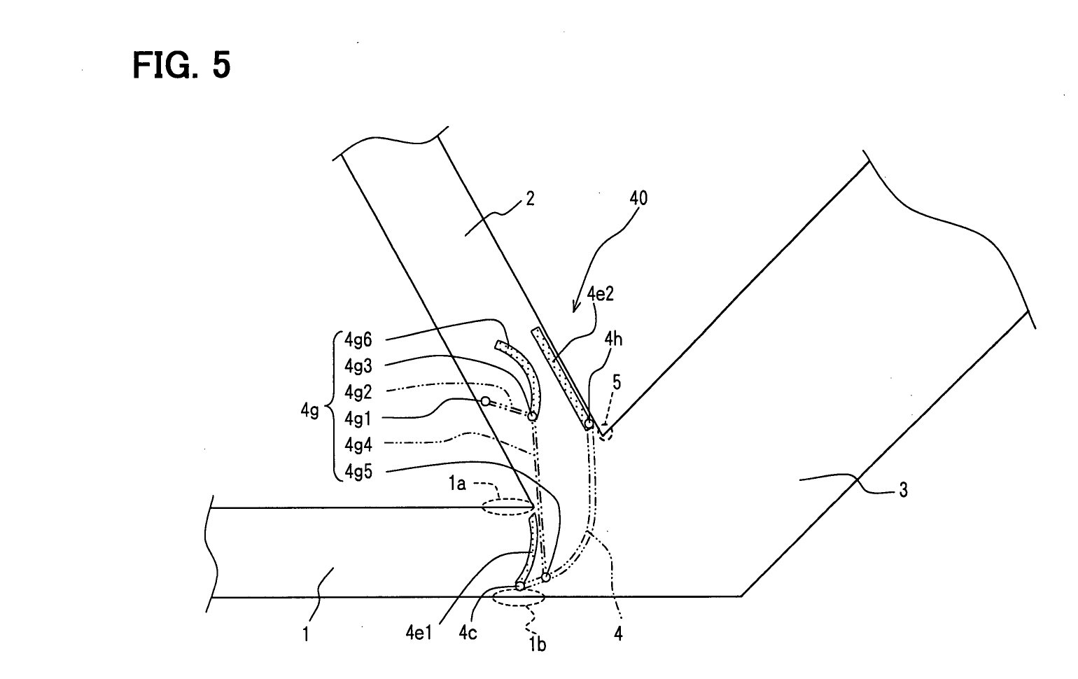

The operation of the fluid passage selecting device 40 according to the second embodiment will be described referring to FIG. 4 and FIG. 5. FIG. 4 shows a state where the second passage 2 is closed by the slide door 4 due to the link unit 4g and air from the first passage 1 is introduced into the third passage 3. In contrast, FIG. 5 shows a state where the third passage 3 is closed by the slide door 4, and air from the first passage 1 is introduced into the second passage 2.

At first, as shown in FIG. 4, the first link pin 4g1, which is linked rotatabely with the motor shaft of the servomotor rotatablely, is operated so that the first link pillar 4g2 is positioned at an uppermost end of the first guiding groove 4g6 in the extending direction of the second passage 2 relative to a lowest end.

Accordingly, the second link pillar 4g4, which is joined with the first link pillar 4g2 rotatablely through the second link pin 4g3, is placed in the second passage 2 in maximum. Further, the slide door 4, which is joined with the second link pillar 4g4 rotatablely through the third link pin 4g5, is placed in the second passage 2 in maximum. In this case, the one end 4c of the slide door 4 reaches an upper end of the second guiding groove 4e1 and contacts the top end 1a of the first passage 1. Moreover, the other end 4h of the slide door 4 reaches an upper end of the third guiding groove 4e2. Further, the bend portion 4a of the slide door 4 substantially contacts the branch point 5.

By the operation of the link unit 4g, the state shown in FIG. 4 becomes that shown in FIG. 5, as described below.
(1) At first, the servomotor clockwise rotates only by a predetermined angle, and the first link pin 4g1 contacting the motor shaft of the servomotor clockwise rotates by the predetermined angle.
(2) When the first link pin 4g1 clockwise rotates by the predetermined angle, the first link pillar 4g2 rotates by the predetermined angle integrally with the first pin 4g1.
(3) When the first link pillar 4g2 clockwise rotates by only a predetermined angle, the second link pin 4g3, which is joined with the other end of the first link pillar 4g2, slides approximately downward along the first guiding groove 4g6.
(4) When the second link pin 4g3 slides approximately downward along the first guiding groove 4g6, the second link pillar 4g4, which is linked rotatablely with the second link pin 4g3, slides approximately down in accordance with the sliding operation of the second link pin 4g3.
(5) When the second link pillar 4g4 slides approximately down, an approximately downward force is applied to the slide door 4 by the third link pin 4g5 that is linked rotatablely with the other end of the second link pillar 4g4.
(6) When the approximately downward force is applied to the slide door 4, the pins disposed at the ends 4c and 4h of the slide door 4 slide approximately downward along the second guiding groove 4e1 and the third guiding groove 4e2 because the pins of the slide door 4 are slideably inserted in the second guiding groove 4e1 and the third guiding groove 4e2, respectively.
(7) When the servomotor finishes its rotation by the predetermined angle, the one end 4c of the slide door 4 substantially contacts the bottom end 1b of the first passage 1. That is, the one end 4c of the slide door 4 reaches a lower end portion of the second guiding groove 4e1.

After the course from (1) to (7) orderly, the state shown in FIG. 4 becomes that shown in FIG. 5.

As shown in FIG. 5, the first link pin 4g1, which is linked rotatablely with the motor shaft of the servomotor, is operated so that the first link pillar 4g2 is positioned at a lowest end of the first guiding groove 4g6.

Accordingly, the second link pillar 4g4, which is joined with the first link pillar 4g2 rotatablely through the second link pin 4g3, is put out of the second passage 2 in maximum. Further, the slide door 4, which is joined with the second link pillar 4g4 rotatablely through the third link pin 4g5, is put out of the second passage 2 in maximum. In this case, the one end 4c of the slide door 4 reaches the lower end of the second guiding groove 4e1 for contacting the other end 1b of the first passage 1, and the other end 4h of the slide door 4 reaches an lower end of the third guiding groove 4e2.

The predetermined rotating angle of the servomotor is beforehand calculated based on a ratio of the fluid flowing from the first passage 1 to that flowing into the second passage 2 or the third passage 3. Furthermore, a distance of the one end 4c of the slide door 4 sliding from the top end 1a to the bottom end 1b of the first passage 1 corresponds to the predetermined rotating angle of the servomotor from the state of FIG. 4 to the state of FIG. 5.

As described in the operation (1)-(7), the slide door 4 is slidable from the position shown in FIG. 4 to that shown in FIG. 5 without a stop. However, the slide door 4 can stop at a middle position (a state where air is introduced from the first passage 1 into both of the second passage 2 and the third passage 3) by controlling the predetermined rotating angle of the motor shaft of the servomotor.

Moreover, in anyone of the operation (1)-(7), the other end 4h of the slide door 4 slides along the side wall surface of the second passage 2.

Similar to the first embodiment, according to the second embodiment, the fluid passage selecting device 40 is provided with the single slide door 4 for selecting the two different-width passages without an additional door member such as the butterfly door. Therefore, the resistance to air flow is effectively decreased.

### Third Embodiment

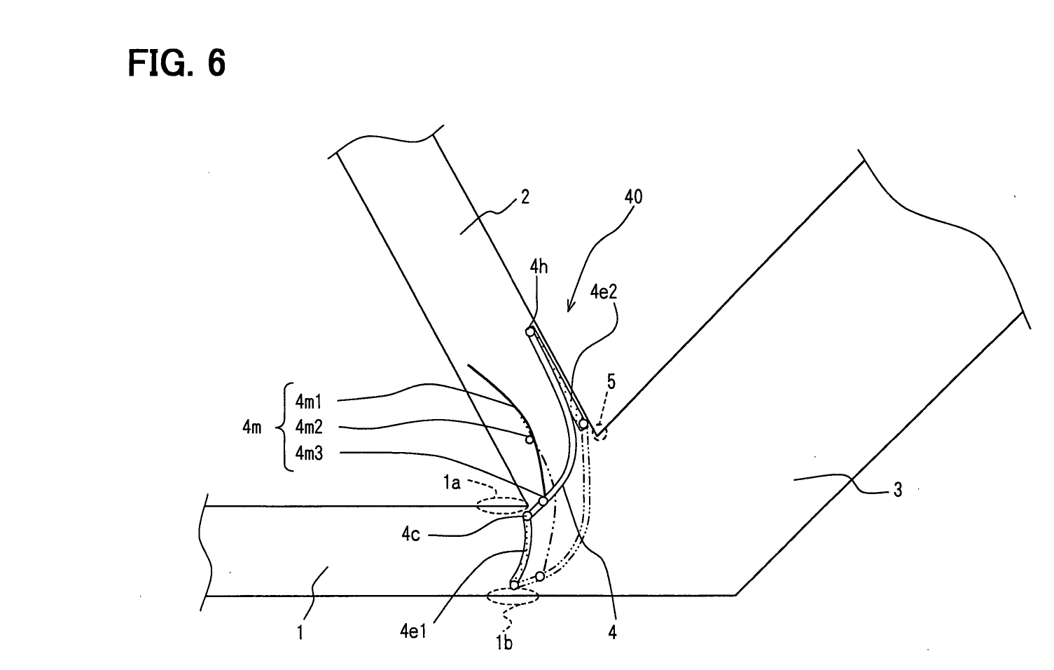

In the above-described second embodiment, by using the link unit 4g provided with the multiple link pillars and the multiple link pins, the slide door 4 is slidable approximately up and down. As shown in FIG. 6, in the third embodiment, a slide unit 4m is used for sliding the slide door 4.

A structure of the slide unit 4m is shown in FIG. 6. The slide unit 4m includes a door pillar 4m1, a pinion 4m2 and a connection portion 4m3.

The door pillar 4m1 is fixedly joined with the side surface of the slide door 4, facing the second passage 2, by the connection portion 4m3. Racks (not shown) are provided in a surface of the door pillar 4m1 at a side near the first passage 1.

The pinion 4m2 is disposed between the door pillar 4m1 and an inner wall of the second passage 2, adjacent to the first passage 1. The pinion 4m2 mashes with racks provided on the door pillar 4m1 and is linked rotatablely with the motor shaft of the servomotor (not shown) to be rotatable integrally with the motor shaft.

The connection portion 4m3 is a welding portion for tightly fixing the door pillar 4m1 to the slide door 4 so that the door pillar 4m1 and the slide door 4 are integrally rotated.

The operation of this embodiment will be described as following.

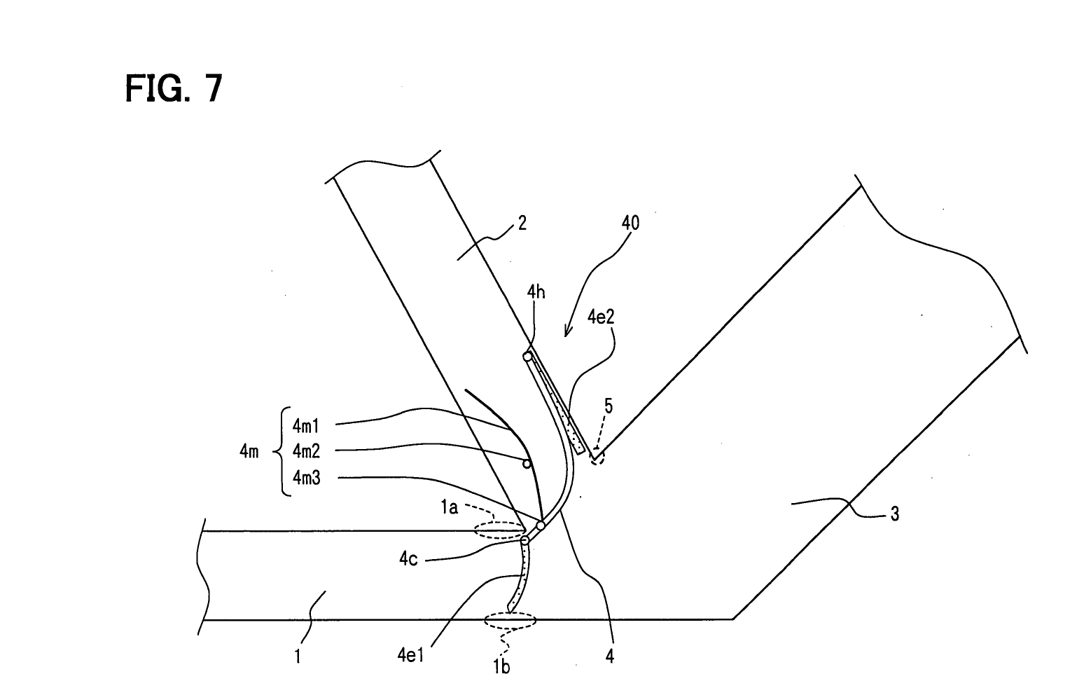

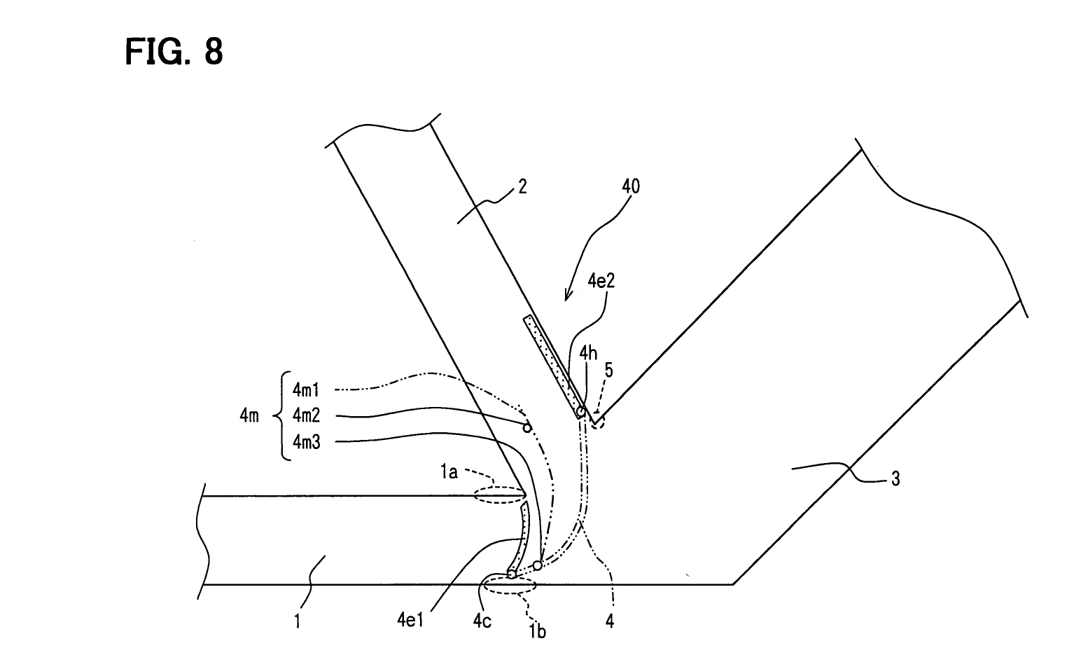

According to the third embodiment, in FIG. 7, air from the first passage 1 is introduced into the third passage 3 by closing the second passage 2. In FIG. 8, air from the first passage 1 is introduced into the second passage 2 by closing the third passage 3.

A relative position of the slide door 4, the first passage 1 and the second passage 2 shown in FIG. 7 is the same as that shown in FIG. 4 of the second embodiment.

The course from the state of FIG. 7 to the state of FIG. 8 is described as follow.
(1) The motor shaft of the servomotor (not shown) clockwise rotates by a predetermined angle, so that the pinion 4m2, connected to the motor shaft to rotate integrally with the motor shaft, clockwise rotates by the predetermined angle.
(2) When the pinion 4m2 clockwise rotates by the predetermined angle, the door pillar 4m1 slides approximately down because the rocks in the door pillar 4m1 mashes with the pinion 4m2.
(3) When the door pillar 4m1 slides approximately down, an approximately downward force is applied to the slide door 4 that is fixed with the door pillar 4m1 tightly.
(4) When the approximately downward force is applied to the slide door 4, the pins disposed at the ends 4c and 4h of the slide door 4 slide approximately downward along the second guiding groove 4e1 and the third guiding groove 4e2, respectively.
(5) When the servomotor finishes its rotation by the predetermined angle, the one end 4c of the slide door 4 substantially contacts the bottom end 1b of the first passage 1. That is, the one end 4c of the slide door 4 reaches a lower end portion of the guiding groove 4e1.

Therefore, the state of the slide door 4 shown in FIG. 7 becomes that shown in FIG. 8.

In FIG. 8, the door pillar 4m1 is put out of the second passage 2 by the operation of the pinion 4m2, which is linked rotatablely with the motor shaft of the servomotor.

Accordingly, the slide door 4, which is tightly fixed with the door pillar 4m1, is put out of the second passage 2 in maximum. In this case, similar to the second embodiment, the one end 4c of the slide door 4 reaches the lower end of the second guiding groove 4e1 for contacting the bottom end 1b of the first passage 1, and the other end 4h of the slide door 4 reaches a lower end of the third guiding groove 4e2.

Moreover, in the state of FIG. 8, air blown from the scroll casing 301a can flow into the second passage 2 smoothly, because the bend portion 4a is bent approximately in the scrolling direction of the scroll casing 301a.

The predetermined rotating angle of the servomotor is beforehand calculated based on the ratio of the fluid flowing from the first passage 1 to that flowing into the second passage 2 or the third passage 3. Furthermore, the distance of the one end 4c of the slide door 4 sliding from the top end 1a to the bottom end 1b of the first passage 1 corresponds to the predetermined rotating angle of the servomotor from the state of FIG. 7 to the state of FIG. 8.

As described in the operation (1)-(5), the slide door 4 is slidable from the position shown in FIG. 7 to that shown in FIG. 8 without a stop. However, the slide door 4 can stop at a middle position (a state where air is introduced from the first passage 1 into both of the second passage 2 and the third passage 3) by controlling the predetermined rotating angle of the motor shaft of the servomotor.

Moreover, in anyone of the operation (1)-(5), the other end 4h of the slide door 4 slides along the side wall surface of the second passage 2.

Similar to the first and second embodiments, according to the third embodiment, the fluid passage selecting device 40 is provided with the single slide door 4 for selectively switching at least one of the two different-width passages without using an additional door member such as the butterfly door. Therefore, the resistance to air flow is effectively decreased.

### Other Embodiment

Although the present invention has been fully described in connection with the preferred embodiments thereof with reference to the accompanying drawings, it is to be noted that various changes and modifications will become apparent to those skilled in the art. For example, in the above-described embodiments, the bend portion 4a is infinitely close to the branch point 5 between the second passage 2 and the third passages 3 but not physically completely contacts the branch point 5. However, the present invention is not limited to this. The bend portion 4a can physically completely contact the branch point 5.

In the above-described embodiments, the heating heater exchanger (i.e., heater core 320) is disposed at a downstream side of the second passage 2 and the cooling heater exchanger (i.e., evaporator 330) is disposed at a downstream side of the third passage 3. However, the present invention is not limited to this. Positions of the heating and cooling heater exchangers can be exchanged.

Moreover, in the above-described embodiments, the bend portion 4a is formed in a bent shape bending in the scrolling direction. However, the present invention is not limited to this. The bend portion 4a can be formed in a folded shape.

Such changes and modifications are to be understood as being within the scope of the present invention as defined by the appended claims.

1. A fluid passage selecting device comprising:
a first member for defining a first passage through which a fluid flows;
a second member for defining a second passage at a downstream side of the first passage in a fluid flow direction;
a third member for defining a third passage at a downstream side of the first passage in the fluid flow direction, the third passage having a width different from that of the second passage; and
a slide door for opening and closing the second and the third passages so that air from the first passage is introduced to at least one of the second and the third passages, wherein:
the slide door has a first end that is slidable between one end side and other end side of a downstream edge portion of the first passage, and a second end that is slidable along an extending direction of one of the second passage and the third passage.

2. The fluid passage selecting device according to claim 1, further comprising a pinion for driving the slide door, wherein:
the slide door has a line portion moved along a wall surface of the second passage; and
the pinion is disposed to mesh with racks provided on the line portion.

3. The fluid passage selecting device according to claim 1, further comprising a link unit for transmitting a driving force from a servomotor to the slide door, the link unit including:
a first link pin joined with the servomotor;
a first link pillar having one end joined with the first link pin to be moved integrally with the first link pin;
a second link pin joined with the other end of the first link pillar;
a second link pillar having one end joined with the second link pin to be moved integrally with the second link pin; and
a third link pin joined with the other end of the second link pillar to be moved integrally with the second link pillar,
wherein the slide door is driven by the servomotor through the link unit to be slidable approximately in the extending direction.

4. The fluid passage selecting device according to claim 1, further comprising at a slide unit for transmitting a driving force from a servomotor to the slide door, the slide unit including:
a door pillar joined with a surface of the slide door in the second passage;
a pinion mashing with racks provided on the door pillar and joined with a servomotor for driving the slid door; and
a connection portion for joining the door pillar with the slide door,
wherein the slide door is driven by the servomotor through the slide unit to be slidable.

5. The fluid passage selecting device according to claim 1, wherein the slide door has a bend portion for changing a flow direction of the fluid flowing from the first passage to one of the second and the third passages.

6. The fluid passage selecting device according to claim 5, wherein the bend portion of the slide door contacts or substantially contacts a branch portion where the second and the third passages are branched from each other when the second end of the slide door slides along the second passage to close the second passage.

7. The fluid passage selecting device according to claim 5, wherein:
the fluid is air blown from a blower fan;
the first passage is an air blowing passage portion of a scroll casing in which the blower fan is disposed; and
the bend portion of the slide door is bent approximately in a scrolling direction of the scroll casing.

8. The fluid passage selecting device according to claim 7, wherein the second passage is connected to the first passage at an inner side of the third passage in the scrolling direction to have a pressure loss larger than that of the third passage.

9. The fluid passage selecting device according to claim 8, wherein:
the second passage has a foot opening at a downstream side, through which air flows to a lower side of a compartment; and
the third passage has a face opening at a downstream side, through which air flows to an upper side of the compartment.
